(19) United States
(12) Patent Application Publication
(10) Pub. No.: US 2013/0218791 A1
(43) Pub. Date: Aug. 22, 2013

(54) DEVICE MANAGEMENT APPARATUS, DEVICE MANAGEMENT SYSTEM, AND COMPUTER-READABLE STORAGE MEDIUM

(71) Applicant: Yuuki OGAWA, Kanagawa (JP)

(72) Inventor: Yuuki OGAWA, Kanagawa (JP)

(21) Appl. No.: 13/770,023

(22) Filed: Feb. 19, 2013

(30) Foreign Application Priority Data
Feb. 22, 2012 (JP) 2012-036517
Jan. 28, 2013 (JP) 2013-013637

(51) Int. Cl. G06Q 30/00

(52) U.S. Cl. CPC G06Q 30/0185
USPC 705/318

(57) ABSTRACT

A device management apparatus for managing a device includes a contract information acquiring unit configured to acquire contract information on the device; a status information acquiring unit configured to acquire status information indicating a status of the device; a checking unit configured to check whether the status of the device complies with a content of a contract based on the contract information and the status information; a generating unit configured to generate status history information in which a check result obtained by the checking unit is associated with the status information; and an output unit configured to output the status history information.

### CROSS-REFERENCE TO RELATED APPLICATIONS

The present application claims priority to and incorporates by reference the entire contents of Japanese Patent Application No. 2012-036517 filed in Japan on Feb. 22, 2012 and Japanese Patent Application No. 2013-013637 filed in Japan on Jan. 28, 2013.

### BACKGROUND OF THE INVENTION

1. Field of the Invention

The present invention relates to a device management apparatus, a device management system, and a computer-readable storage medium.

2. Description of the Related Art

In recent years, in some cases where a device, such as an image forming apparatus, is introduced to a customer, an SLA (Service Level Agreement) contract including guaranteed items, such as occurrence of a specific state or an upper limit value of a duration of the specific state, is signed in order to assure the quality of a maintenance service of the device given to the customer.

In general, the SLA contract is continuously checked and reviewed by the PDCA cycle with steps of preparation of the SLA contract (Plan), execution of a service (Do), monitoring and evaluation of the service (Check), and review of the SLA contract (Action).

If a failure occurs in the device, in general, a service person of a maintenance service provider registers failure information, such as details of the failure, date and time when the failure occurs, and date and time when the failure is resolved, in a database. Therefore, at the Check step for the SLA contract, the failure information registered in the database is compared with the guaranteed items of the SLA contract to see if the SLA contract is fulfilled. At the Action step for the SLA contract, a service is improved or the SLA contract is reviewed according to the check result. A technology similar to the above-described technology is disclosed in, for example, Japanese Patent Application Laid-open No. 2007-42011.

However, in the conventional technology as described above, although it is possible to check whether the contents of a contract are fulfilled, it is impossible to check a relationship between fulfillment or non-fulfillment of the contents of the contract and actual usage of the device. Therefore, it has been difficult to provide useful information to improve a service or to review the contents of a contract.

Therefore, there is a need for a device management apparatus, a device management system, and a computer-readable storage medium capable of providing useful information to improve a service or to review the content of a contract.

### SUMMARY OF THE INVENTION

It is an object of the present invention to at least partially solve the problems in the conventional technology.

According to an embodiment, there is provided a device management apparatus that includes a contract information acquiring unit configured to acquire contract information on a device; a status information acquiring unit configured to acquire status information indicating a status of the device; a checking unit configured to check whether the status of the device complies with a content of a contract based on the contract information and the status information; a generating unit configured to generate status history information in which a check result obtained by the checking unit is associated with the status information; and an output unit configured to output the status history information.

According to another embodiment, there is provided a device management system that includes a device management apparatus for managing a device; a contract information storage device configured to store therein contract information on the device; and a status history information storage device configured to store therein status history information. The device management apparatus includes a contract information acquiring unit configured to acquire the contract information from the contract information storage device; a status information acquiring unit configured to acquire status information indicating a status of the device; a checking unit configured to check whether the status of the device complies with a content of a contract based on the contract information and the status information; a generating unit configured to generate the status history information in which a check result obtained by the checking unit is associated with the status information; and an output unit configured to output the status history information to the status history information storage device.

According to still another embodiment, there is provided a non-transitory computer-readable storage medium with an executable program stored thereon. The program instructs a computer for managing a device to perform: acquiring contract information on the device; acquiring status information indicating a status of the device; checking whether the status of the device complies with a content of a contract based on the contract information and the status information; generating status history information in which a check result obtained at the checking is associated with the status information; and outputting the status history information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration example of a device management system according to an embodiment;

FIG. 2 is a block diagram illustrating a configuration example of a device management apparatus according to the embodiment;

FIG. 3 is a diagram illustrating an example of SLA information according to the embodiment;

FIG. 4 is a diagram illustrating an example of device information according to the embodiment;

FIG. 5 is a diagram illustrating an example of status information according to the embodiment;

FIG. 6 is a diagram illustrating an example of status history information according to the embodiment;

FIG. 7 is a flowchart illustrating an example of a process performed by the device management apparatus according to the embodiment;

FIG. 8 is a block diagram illustrating a configuration example of a device management system according to a modification;

FIG. 9 is a block diagram illustrating a configuration example of a device management apparatus according to the modification; and

FIG. 10 is a block diagram illustrating an example of a hardware configuration of the device management apparatus according to the embodiment and the modification.

### DETAILED DESCRIPTION OF THE PREFERRED EMBODIMENTS

Exemplary embodiments of the present invention will be explained in detail below with reference to the accompanying drawings.

A configuration of a device management apparatus according to an embodiment will be explained below.

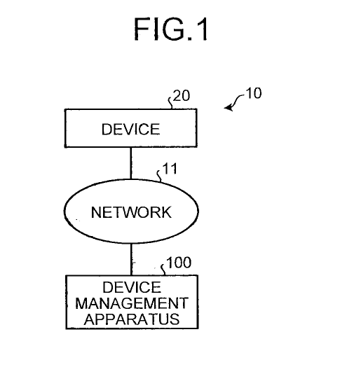

FIG. 1 is a block diagram illustrating a configuration example of a device management system 10 according to the embodiment. As illustrated in FIG. 1, the device management system 10 includes a device 20 and a device management apparatus 100. The device 20 and the device management apparatus 100 are connected to each other via a network 11. The network 11 is realized by, for example, a LAN (Local Area Network) or the Internet.

In the embodiment, the device 20 and the device management apparatus 100 are installed in a service site of a service provider that provides a device management service. The service site corresponds to, for example, an office of a company that receives the device management service. However, the installation location of the device management apparatus 100 is not limited to the service site, but may be a service center or the like.

The device management apparatus 100 manages the device 20, and is realized by a PC (Personal Computer) in which a device management program is installed. The device 20 may be any device as long as the device is connectable to the network 11. Examples of the device 20 include an image forming apparatus, such as a printer, a copier, a multifunction peripheral (MFP), a scanner, or a facsimile machine, various electronic devices, such as a projector, a camera, an air conditioner, a refrigerator, a fluorescent light, an automatic vending machine, or a handheld terminal, and an information processing apparatus, such as a PC. The MFP is a device having at least two of a copying function, a printing function, a scanner function, and a facsimile function.

In FIG. 1, an example is illustrated in which the device 20 that is an MFP is employed as a device to be managed by the device management apparatus 100. However, the device to be managed by the device management apparatus 100 is not limited to this example.

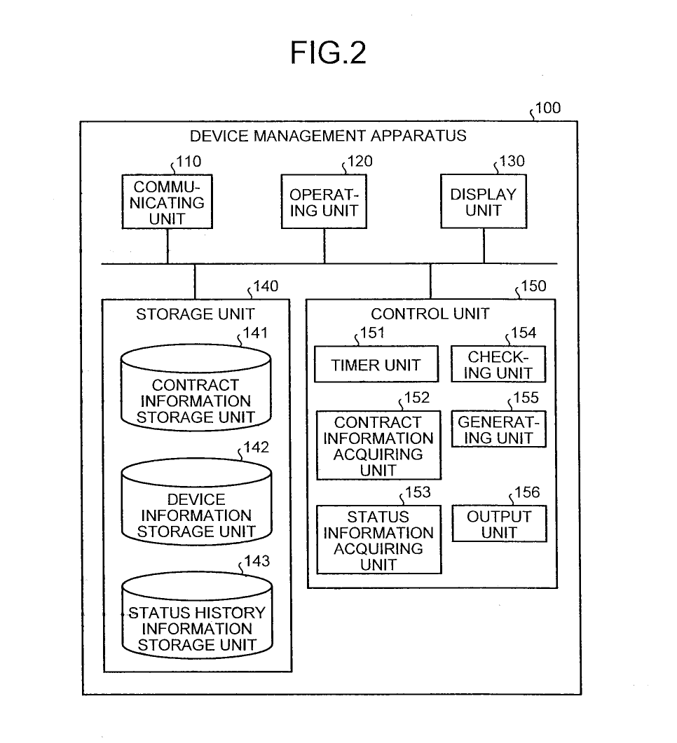

FIG. 2 is a block diagram illustrating a configuration example of the device management apparatus 100 according to the embodiment. As illustrated in FIG. 2, the device management apparatus 100 includes a communicating unit 110, an operating unit 120, a display unit 130, a storage unit 140, and a control unit 150.

The communicating unit 110 performs communication with the device 20 via the network 11, and is realized by a communication device, such as a network interface card (NIC).

The operating unit 120 inputs and outputs various operations, and is realized by at least one of input devices such as a keyboard, a mouse, a touch pad, and a touch panel.

The display unit 130 displays various screens, and is realized by a display device, such as a liquid crystal display or a touch panel display.

The storage unit 140 stores therein various programs, such as the device management program executed by the device management apparatus 100, data used in various processes performed by the device management apparatus 100, or the like. The storage unit 140 is realized by, for example, at least one of magnetic, optical, and electrical storage devices such as a hard disk drive (HDD), a solid state drive (SSD), a memory card, an optical disk, a read only memory (ROM), and a random access memory (RAM).

The storage unit 140 includes a contract information storage unit 141, a device information storage unit 142, and a status history information storage unit 143.

The contract information storage unit 141 stores therein contract information on a device to be managed by the device management apparatus 100. Examples of the contract information include an SLA (Service Level Agreement) contract on the service quality of operations of the device to be managed. In the embodiment, the contract information storage unit 141 stores therein a plurality of pieces of SLA information indicating contents of the SLA contract in a file format.

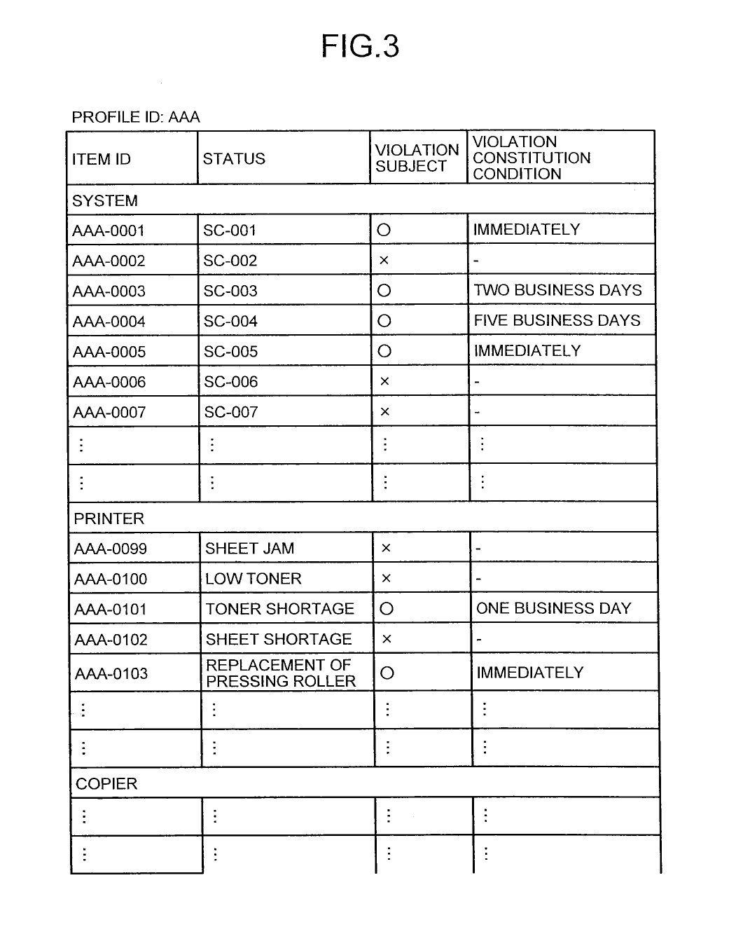

FIG. 3 is a diagram illustrating an example of the SLA information according to the embodiment, in particular, the SLA information for a profile ID “AAA”. In the example illustrated in FIG. 3, the SLA information indicates whether a status of each of items is a subject of an SLA violation (hereinafter, the status of an item to be a subject of the SLA violation may be described as a specific state), and a period that constitutes the SLA violation with respect to the status of the item being the subject of the SLA violation. For example, it is indicated that sheet jam with an item ID “AAA-0099” does not constitute the SLA violation, toner shortage with an item ID “AAA-0101” constitutes the SLA violation if it continues for one business day from an occurrence of the toner shortage (over one business day), and replacement of a pressing roller with an item ID “AAA-0103” constitutes the SLA violation immediately after the replacement occurs. Namely, the SLA information indicates that the contract violation occurs upon occurrence of a specific status or when the specific state continues for a certain period.

The device information storage unit 142 stores therein device information on a device to be managed by the device management apparatus 100. In the embodiment, the device information storage unit 142 stores therein the device information in a file format for each of devices to be managed.

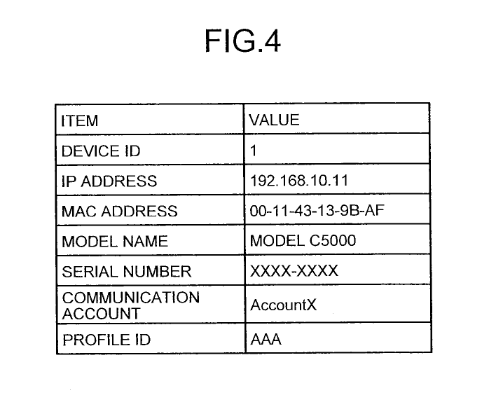

FIG. 4 is a diagram illustrating an example of the device information according to the embodiment, in particular, the device information on the device 20. In the example illustrated in FIG. 4, the device information contains device identification information, such as a device ID, an IP (Internet Protocol) address, a MAC (Media Access Control) address, a model name, a serial number, and a communication account, in association with a profile ID of the SLA information applied to the device (the device 20) indicated by the device identification information. In this example, the profile ID is “AAA” and the SLA information illustrated in FIG. 3 is applied to the device 20.

The status history information storage unit 143 stores therein status history information to be described later. Details of the status history information storage unit 143 will be explained later.

The control unit 150 controls each of the units of the device management apparatus 100, and is realized by a control device, such as a central processing unit (CPU). The control unit 150 includes a timer unit 151, a contract information acquiring unit 152, a status information acquiring unit 153, a checking unit 154, a generating unit 155, and an output unit 156. The control unit 150 activates (executes) the device management program stored in the storage unit 140, to thereby realize the contract information acquiring unit 152, the status information acquiring unit 153, the checking unit 154, the generating unit 155, and the output unit 156 as software. The timer unit 151 may be provided as a function that is also realized by activating the device management program.

The timer unit 151 measures time.

The contract information acquiring unit 152 acquires contract information on quality assurance of the device 20. Specifically, the contract information acquiring unit 152 acquires the device information on the device 20 from the device information storage unit 142, and acquires the SLA information indicated by a profile ID set in the acquired device information from the contract information storage unit 141. In the embodiment, the contract information acquiring unit 152 acquires the device information illustrated in FIG. 4 from the device information storage unit 142, and acquires the SLA information illustrated in FIG. 3 from the contract information storage unit 141 because the profile ID “AAA” is set in the acquired device information.

The status information acquiring unit 153 acquires status information indicating a status of the device 20 from the device 20. The status information acquiring unit 153 periodically acquires the status information of the device 20. In the embodiment, the status information acquiring unit 153 communicates with the device 20 by using a protocol such as Simple Network Management Protocol (SNMP) every time a predetermined time is measured by the timer unit 151, and acquires the status information. In the embodiment, the predetermined time is assumed as one hour; however, it is not limited thereto.

The method for acquiring the status information is not limited to the above method, in which the status information acquiring unit 153 sends a request to the device 20 to provide the status information and acquires the status information from the device 20. For example, a method may be employed, in which the device 20 actively notifies the device management apparatus 100 (the status information acquiring unit 153) of the status information.

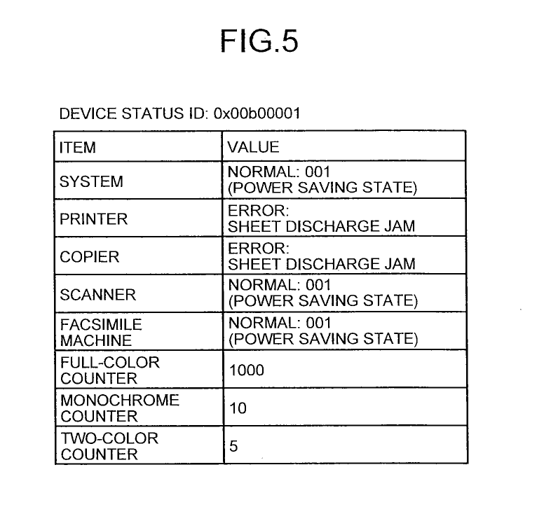

FIG. 5 is a diagram illustrating an example of the status information according to the embodiment, in particular, the status information on the device 20 with a device status ID “0x00b00001”. In the example illustrated in FIG. 5, the status information indicates statuses (values) of a system, a printer, a copier, a scanner, and a facsimile machine, as well as statuses (values) of a full-color counter, a monochrome counter, and a two-color counter.

The checking unit 154 checks whether or not the status of the device 20 complies with the contents of a contract based on the contract information acquired by the contract information acquiring unit 152 and the status information acquired by the status information acquiring unit 153. In this example, the checking unit 154 checks whether the status of the device 20 complies with the contents of the contract based on the status information and the contract information every time the status information acquiring unit 153 acquires the status information.

Specifically, the checking unit 154 refers to the SLA information (see FIG. 3) acquired by the contract information acquiring unit 152, and checks whether or not the status of each of the items indicated by the status information (see FIG. 5) acquired by the status information acquiring unit 153 is a subject of the SLA violation. If the status of any of the items is the subject of the SLA violation, the checking unit 154 checks whether or not the status (specific state) of the item has continued for a period that constitutes the SLA violation.

If the period that constitutes the SLA violation for an item indicates an immediate time, because the status has already continued for the period that constitutes the SLA violation, the checking unit 154 determines that the item constitutes the SLA violation. Specifically, when the SLA information defines a status of an item that constitutes the SLA violation upon occurrence of the status, and if the status information acquiring unit 153 acquires the status information indicating the status (specific state) of the item, the checking unit 154 determines, as a check result, that there is the SLA violation with respect to the item.

Furthermore, if the period that constitutes the SLA violation indicates other than an immediate time, the checking unit 154 measures, on the storage unit 140, the number of times that the status information acquiring unit 153 continues to acquire the status information indicating the status of the item. The checking unit 154 calculates a duration of the status of the item based on the number of continuous acquisitions and based on an interval (in the embodiment, one hour) between the acquisitions of the status information by the status information acquiring unit 153. If the calculated duration reaches the period that constitutes the SLA violation, the checking unit 154 determines that the SLA violation has occurred with respect to the item. The checking unit 154 restores the number of continuous acquisitions to an initial value when the status information acquiring unit 153 acquires the status information that does not indicate the status of the item.

Specifically, when the SLA information defines a status of an item that constitutes the SLA violation upon continuation of the status for a predetermined period, and if the status information acquiring unit 153 continues to acquire the status information indicating the status (specific state) of the item and a duration of the status of the item reaches the predetermined period, the checking unit 154 determines, as a check result, that the SLA violation has occurred with respect to the item.

When the checking unit 154 checks whether or not the status of the device 20 complies with the contents of the contract based on the contract information illustrated in FIG. 3 and the status information illustrated in FIG. 5, because a system is normal and a sheet discharge jam (sheet jam) in a printer does not constitute the SLA violation, the checking unit 154 determines, as the check result, that no SLA violation has occurred.

The generating unit 155 generates status history information in which the check result obtained by the checking unit 154 is associated with the status information acquired by the status information acquiring unit 153. Specifically, the generating unit 155 generates the status history information by adding the check result obtained by the checking unit 154 to the status information acquired by the status information acquiring unit 153. The generating unit 155 generates the status history information when the check result obtained by the checking unit 154 indicates that there is the SLA violation.

The output unit 156 outputs the status history information. Specifically, when the check result obtained by the checking unit 154 indicates that there is the SLA violation, the output unit 156 outputs the status history information generated by the generating unit 155. When the check result obtained by the checking unit 154 indicates that there is no SLA violation, the output unit 156 outputs the status information acquired by the status information acquiring unit 153 as the status history information. In the embodiment, the output unit 156 outputs the status history information to the status history information storage unit 143.

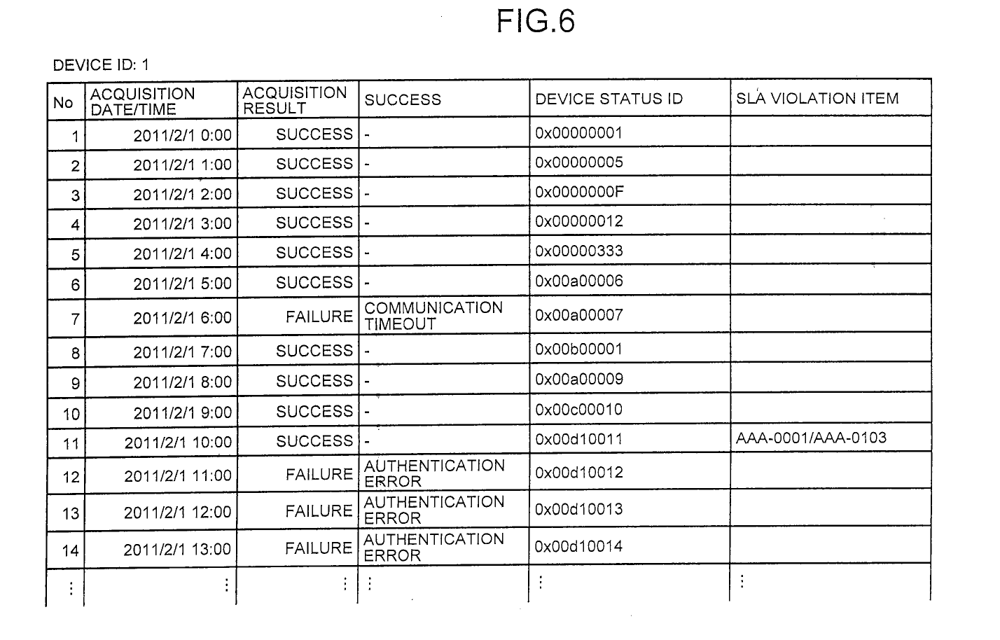

FIG. 6 is a diagram illustrating an example of the status history information stored in the status history information storage unit 143 according to the embodiment, in particular, the status history information with a device ID “1” (the device 20). In the example illustrated in FIG. 6, the status history information contains a number No, date and time when the status information acquiring unit 153 acquires the status information, a result of acquisition of the status information, details about a failure of acquisition, a device status ID, and an SLA violation item, all of which are associated with one another. In the status history information illustrated in FIG. 6, SLA violation items “AAA-0001” and “AAA-0103” (see FIG. 3) are added to the device status ID “0x00d10011” of No. “11”.

The device management apparatus 100 does not necessarily have to include all of the units described above, and a part of the units may be omitted.

Operations of the device management system according to the embodiment will be explained below.

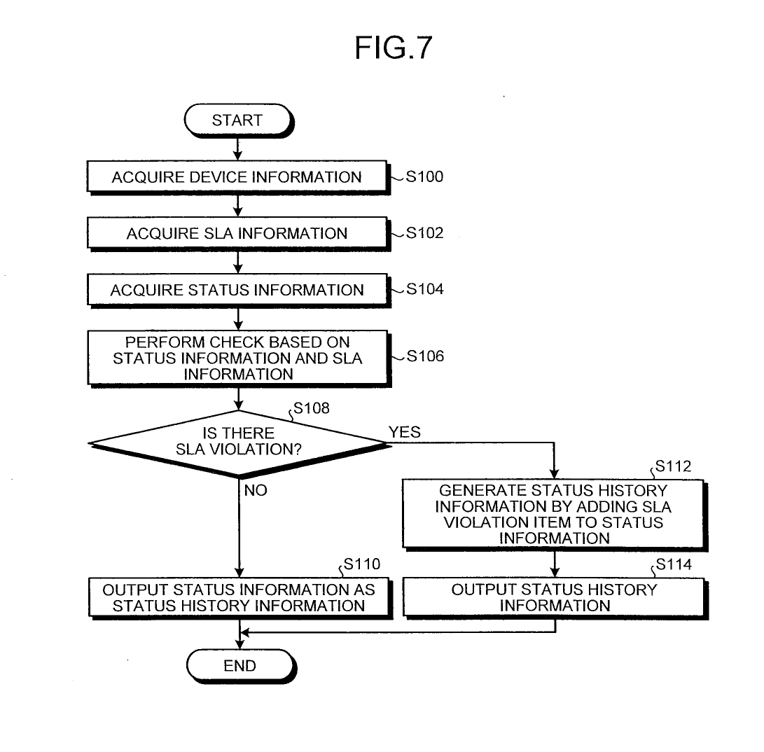

FIG. 7 is a flowchart illustrating an example of a process performed by the device management apparatus 100 according to the embodiment.

The contract information acquiring unit 152 acquires the device information on the device 20 from the device information storage unit 142 (Step S100).

The contract information acquiring unit 152 acquires the SLA information indicated by a profile ID set in the acquired device information from the contract information storage unit 141 (Step S102).

The status information acquiring unit 153 acquires the status information on the device 20 from the device 20 when a predetermined time is measured by the timer unit 151 (Step S104).

The checking unit 154 checks whether or not the status of the device 20 complies with the contents of a contract based on the contract information acquired by the contract information acquiring unit 152 and the status information acquired by the status information acquiring unit 153 (Step S106).

When the check result obtained by the checking unit 154 indicates that there is no SLA violation (NO at Step S108), the output unit 156 outputs the status information acquired by the status information acquiring unit 153 as the status history information to the status history information storage unit 143 (Step S110).

On the other hand, when the check result obtained by the checking unit 154 indicates that there is the SLA violation (YES at Step S108), the generating unit 155 generates the status history information by adding the check result (an SLA violation item) obtained by the checking unit 154 to the status information acquired by the status information acquiring unit 153 (Step S112).

The output unit 156 outputs the status history information generated by the generating unit 155 to the status history information storage unit 143 (Step S114).

As described above, according to the embodiment, the status history information is generated by adding an SLA violation item to the status information of a device. Therefore, by referring to the status history information, it becomes possible to not only check whether the contents of an SLA contract is fulfilled, but also check a relationship between fulfillment or non-fulfillment of the contents of the contract and actual usage of the device. Therefore, according to the embodiment, it is possible to provide useful information to improve a service or to review the contents of the SLA contract.

Modification

The present invention is not limited to the above embodiment, but may be modified in various forms.

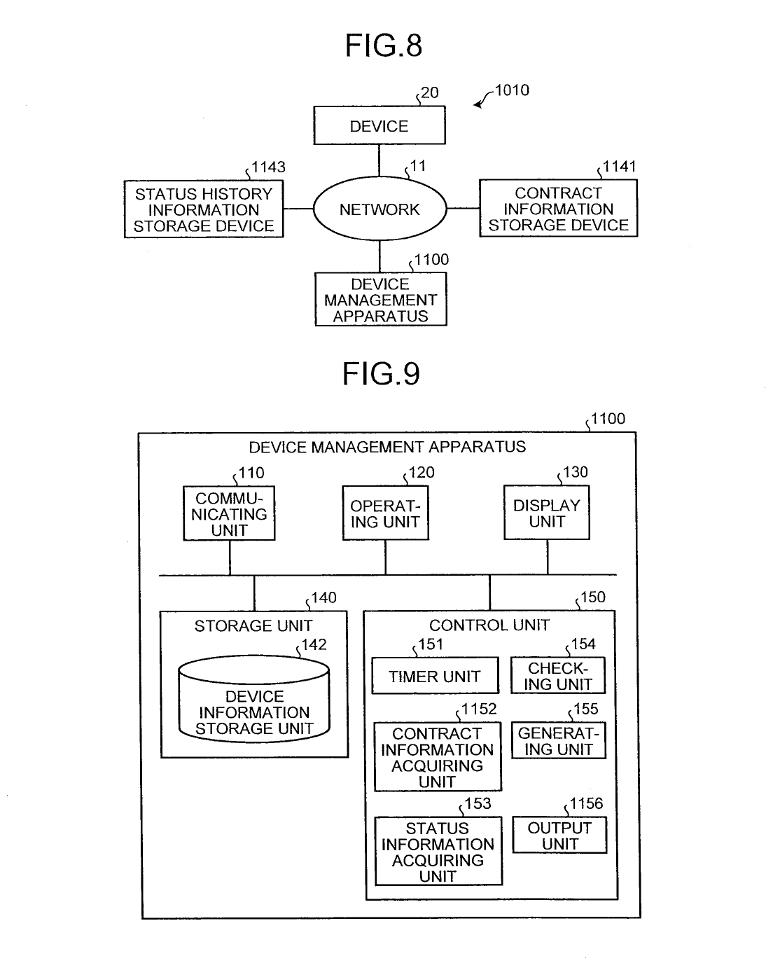

In the embodiment, an example has been explained in which the device management apparatus 100 stores therein the SLA information and the status history information. However, the SLA information and the status history information may be stored in an external apparatus. For example, as in a device management system 1010 illustrated in FIG. 8 and FIG. 9, it may be possible to provide a contract information storage device 1141 for storing the SLA information and a status history information storage device 1143 for storing the status history information in an external system (for example, on a cloud computing), causes a contract information acquiring unit 1152 of a device management apparatus 1100 to acquire the SLA information from the contract information storage device 1141 via the network 11, and cause an output unit 1156 of the device management apparatus 1100 to output the status history information to the status history information storage device 1143 via the network 11.

Hardware Configuration

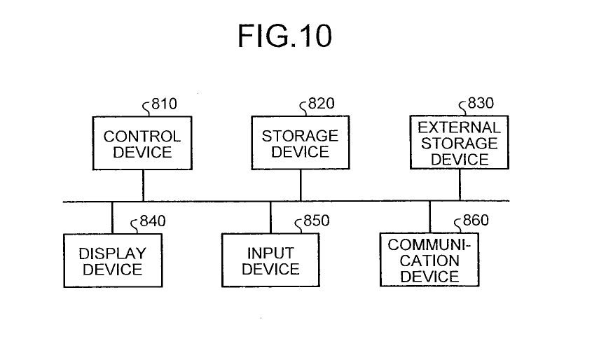

FIG. 10 is a block diagram illustrating an example of a hardware configuration of the device management apparatus according to the embodiment and the modification. As illustrated in FIG. 10, the device management apparatus according to the embodiment and the modification includes a control device 810, such as a CPU, a storage device 820, such as a ROM or a RAM, an external storage device 830, such as an HDD, a display device 840, such as a display, an input device 850, such as a keyboard or a mouse, and a communication device 860, such as a communication interface, and has a hardware configuration using a normal computer.

The device management program executed by the device management apparatus according to the embodiment and the modification is provided by being stored in a computer-readable storage medium, such as a CD-ROM, a CD-R, a memory card, a DVD (Digital Versatile Disk), or a flexible disk (FD), in a computer-installable or a computer-executable file format.

The device management program executed by the device management apparatus according to the embodiment and the modification may be stored in a computer connected to a network, such as the Internet, and be provided by downloading via the network. The device management program executed by the device management apparatus according to the embodiment and the modification may be provided or distributed via a network, such as the Internet. The device management program executed by the device management apparatus according to the embodiment and the modification may be provided by being stored in a ROM or the like in advance.

The device management program executed by the device management apparatus according to the embodiment and the modification has a module structure for realizing the above-described units on a computer. As actual hardware, the CPU loads the program from the HDD onto the RAM and executes the program to realize the above units on the computer.

According to the embodiments, it is possible to provide useful information to improve a service or to review the contents of a contract.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device management apparatus for managing a device, comprising:
a contract information acquiring unit configured to acquire contract information on the device;
a status information acquiring unit configured to acquire status information indicating a status of the device;
a checking unit configured to check whether the status of the device complies with a content of a contract based on the contract information and the status information;
a generating unit configured to generate status history information in which a check result obtained by the checking unit is associated with the status information; and
an output unit configured to output the status history information.

2. The device management apparatus according to claim 1, wherein
the status information acquiring unit periodically acquires the status information, and
the checking unit checks whether the status of the device complies with the content of the contract based on the status information and the contract information every time the status information is acquired.

3. The device management apparatus according to claim 2, wherein
the contract information indicates that a contract violation occurs when a specific state continues for a predetermined period, and
the checking unit determines, as the check result, that the contract violation has occurred when the status information indicating the specific state is continuously acquired and a duration of the specific state reaches the predetermined period.

4. The device management apparatus according to claim 1, wherein
the contract information indicates that a contract violation occurs upon occurrence of a specific state, and
the checking unit determines, as the check result, that the contract violation has occurred when the status information indicating the specific state is acquired.

5. The device management apparatus according to claim 1, wherein the generating unit adds the check result to the status information to generate the status history information.

6. The device management apparatus according to claim 1, wherein
the generating unit generates the status history information when the check result indicates that a contract violation has occurred, and
the output unit outputs the status history information generated by the generating unit when the check result indicates that the contract violation has occurred, and outputs the status information as the status history information when the check result indicates no contract violation has occurred.

7. The device management apparatus according to claim 1, further comprising:
a contract information storage unit configured to store therein the contract information; and
a status history information storage unit configured to store therein the status history information, wherein
the contract information acquiring unit acquires the contract information from the contract information storage unit, and
the output unit outputs the status history information to the status history information storage unit.

8. A device management system, comprising:
a device management apparatus for managing a device;
a contract information storage device configured to store therein contract information on the device; and
a status history information storage device configured to store therein status history information, wherein
the device management apparatus includes
a contract information acquiring unit configured to acquire the contract information from the contract information storage device;
a status information acquiring unit configured to acquire status information indicating a status of the device;
a checking unit configured to check whether the status of the device complies with a content of a contract based on the contract information and the status information;
a generating unit configured to generate the status history information in which a check result obtained by the checking unit is associated with the status information; and
an output unit configured to output the status history information to the status history information storage device.

9. A non-transitory computer-readable storage medium with an executable program stored thereon, wherein the program instructs a computer for managing a device to perform:
acquiring contract information on the device;
acquiring status information indicating a status of the device;
checking whether the status of the device complies with a content of a contract based on the contract information and the status information;
generating status history information in which a check result obtained at the checking is associated with the status information; and
outputting the status history information.
